(19) United States
(12) Patent Application Publication
(10) Pub. No.: US 2019/0065444 A1
(43) Pub. Date: Feb. 28, 2019

(54) Techniques for efficient & high-throughput web content-creation

(71) Applicant: Explica, Inc., Austin, TX (US)

(72) Inventors: Viputheshwar Sitaraman, Austin, TX (US); Fernando Garcia Jr. Luna, Austin, TX (US)

(21) Appl. No.: 15/691,474

(22) Filed: Aug. 30, 2017

(51) Int. Cl. G06F 17/22; H04L 29/08

(52) U.S. Cl. CPC G06F 17/2247; H04L 67/06; G06F 17/212; G06F 17/227; H04L 67/36

(57) ABSTRACT

Systems and methods are disclosed for high-throughput content-creation for the world wide web (WWW). A new text/textual file format referred to as a graphicle is introduced. A graphicle file comprises sections and the sections further specify Uniform Resource Identifier (URI) parameters that are used to construct calls to endpoints of a web-api. When called, the web-api first filters a complete dataset based on the URI parameters to obtain filtered data. Alternatively, it uses the data directly supplied in the URI parameters. It then applies a predefined HTML template to this data, resulting in a fully rendered HTML web page which the web-api returns at its originally called endpoint. The web page is based on HTML5 and is device-responsive. The techniques are applicable to a variety of industry verticals, including sports, entertainment, finance, etc. The system can also be condensed to a locally stored application for deployment on an offline computer.

### STATEMENT OF COPYRIGHT NOTICE

The below-referenced computer program listings appendix and its associated files, and portions of this disclosure are subject to copyright protection and any use thereof, other than as part of the reproduction of the patent document or the patent disclosure, is strictly prohibited. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO COMPUTER PROGRAM LISTINGS APPENDIX

This application includes a computer program listings appendix containing files in ASCII text file format and submitted via EFS-Web. The entire contents of the computer program listings appendix including below named files are incorporated by reference herein in their entireties in this application. The name, size, creation date and a brief description of the files contained in the computer program listings appendix are provided in Table 1 below.

Note that prior to uploading via EFS-Web, the “.html”, “.css”, “.js” and “.json” extensions of the original files as referenced in this disclosure were changed to “_html.txt”, “_css.txt”, “_js.txt” and “_json.txt” respectively.

TABLE 1
Name, size, creation date and a brief description of the files
contained in the submitted computer program listings appendix.

| | Size of the File | | |
|---|---|---|---|
| Name of the File | (bytes) | Creation Date | Brief Description |
| 1. colors_css.txt | 433 | Aug. 24, 2017 | CSS stylesheet to |
| | | | define color variables |
| | | | used by the master |
| | | | stylesheet explica.css |
| 2. denver-nuggets_html.txt | 16,848 | Aug. 24, 2017 | HTML code rendered |
| | | | for Denver Nuggets |
| | | | teamCard (FIG. 7) |
| 3. explica_css.txt | 36,172 | Aug. 24, 2017 | Master CSS stylesheet, |
| | | | including typography |
| | | | sizing and layout |
| | | | definitions |
| 4. lebron-james_gpe_m_decoded.txt | 270 | Aug. 24, 2017 | Exemplary graphicle |
| | | | file in decoded format |
| 5. lebron-james_json.txt | 2,534 | Aug. 24, 2017 | JSON file containing |
| | | | full/unfiltered dataset |
| 6. lebron-james_playerCard_html.txt | 12,674 | Aug. 24, 2017 | HTML code rendered |
| | | | for Lebron James |
| | | | playerCard (FIG. 4) |
| 7. main_js.txt | 5,426 | Aug. 24, 2017 | Contains JavaScript |
| | | | code for various |
| | | | “controllers” |
| 8. playerBanner_template_html.txt | 5,565 | Aug. 24, 2017 | HTML template |
| | | | applied to filtered |
| | | | JSON dataset to |
| | | | render playerBanner |
| 9. playerCard_template_html.txt | 3,381 | Aug. 24, 2017 | HTML template |
| | | | applied to filtered |
| | | | JSON dataset to |
| | | | render playerCard |
| 10. tracy-mcgrady_gpe_n_decoded.txt | 391 | Aug. 24, 2017 | Exemplary graphicle |
| | | | file in decoded format |
| 11. tracy-mcgrady_playerQuote_html.txt | 4,373 | Aug. 24, 2017 | HTML code rendered |
| | | | for Tracy McGrady |
| | | | playerQuote (FIG. 5) |

### FIELD OF THE INVENTION

This invention relates generally to web publishing and more specifically to efficient and high-throughput web publishing infrastructures.

### BACKGROUND ART

In recent years, content publishing for the world wide web (WWW) has seen an explosive growth. This growth has been fueled by a number of factors. Among these are an ever-expanding internet user base and an exponential increase in the usage and “stickiness” of social media websites such as Facebook, LinkedIn, Instagram, etc. Additionally, the amount of web content available even in traditional news media, and products/e-commerce websites has seen a tremendous growth. More and more publishers are seeking ways to generate web content at fast throughputs and with high fidelity and accuracy. At the same time, various industry solutions have focused on ways to make the process of website creation and content management as streamlined as possible.

A popular website creation software Wix (wix.com) allows users to create HTML5 websites and other mobile sites through the use of online drag-and-drop tools. Users can add functionality such as social plugins, e-commerce, contact forms, etc. to their websites using a variety of Wix based or other third-party applications. Similarly, Weebly is a web-hosting service featuring a drag-and-drop website builder. Instant Articles from Facebook is a mobile publishing format that enables news publishers to distribute articles to the Facebook application. These are purported to load and display as much as ten times faster than the standard mobile web.

Furthermore, U.S. Patent Publication No. 2015/0356127 A1 to Pierre et al. discloses techniques for autonomous and automatic real-time publishing of content. In an exemplary embodiment, one or more topic terms are obtained. A set of information that is related to the one or more topic terms is automatically acquired. Linguistic analysis on the above set of information is automatically performed to determine a set of linguistic structures that are represented in the set of information. The set of linguistic structures is used to automatically create a set of content items that are responsive to searches that include the above one or more topic terms. New content that includes the set of content items is then automatically published.

U.S. Pat. No. 7,836,110 B1 to Schoenbach et al. describes a media query system for interpreting one or more requests for media or templates in a framework template based on a user query input. This executes one or more search queries based on the one or more requests for media or templates to locate and download candidates. Candidates are comprised of candidate media elements or candidate template elements. The system then evaluates the candidates for each of the one or more search queries to select winning media candidates comprised of selected candidate media elements and candidate template elements.

NPL reference “Web layout mining using NLP: A Paradigm For Intelligent Web Layout Design” dated 2007 by Bajwa et al. teaches that the problem in designing of modern website projects is to produce content according to the latest trends and styles. According to the reference, the common website editors just help to draw the intended layouts however the remaining problem is that of designing the accurate web layout according to the demand and latest trends and style. Further according to the reference, the traditional approach is useful when the user has a specific layout already in mind and is familiar with the principles of what kind of web page layouts are possible. However, according to the reference, it is intrinsically difficult for particularly those who have limited artistic and creative abilities to design a good layout from scratch that is acceptable in every respect.

The authors suggest that an automated system is required that has the ability to mine the layouts of the desired type of websites. Their designed system for “Web Layout Mining (WLM)” mines the most popular web-layouts from the internet and then designs a web-layout that is nearly acceptable with all modern features. The designed system actually works off of a rule based algorithm which helps the user to search samples related to his/her website category. Then, the user chooses a sample and designs his/her own desired web-layout according to his/her own requirements.

U.S. Patent Publication No. 2012/0191716 A1 to Omoigui discloses an integrated implementation framework and resulting medium for knowledge retrieval, management, delivery and presentation based on web scraping. The system includes a server component that is responsible for adding and maintaining domain-specific semantic information. It further includes another server component that hosts semantic and other knowledge for use by the first server component. The components work together to provide context and time-sensitive semantic information retrieval services to the clients.

Within the system, all objects or events in a given hierarchy are active agents semantically related to each other and representing queries (comprised of underlying action code). The queries return data objects for presentation to a client according to a predetermined and customizable theme. The system provides various means for the client to customize and blend agents and the underlying related queries to optimize the presentation of the resulting information.

U.S. Pat. No. 7,636,792 B1 to Ho teaches a computer system and method configured to deliver content to a mobile device. It includes a server configured to deliver an address of a content in a reference format that is responsive to a content request from the mobile device. There is a proxy server configured to receive from the mobile device, the address of the content in the reference format and the type of the mobile device. The proxy server fetches the requested content at the received address. It then automatically converts the fetched content from the reference format to a format suitable for the type of the mobile device. It then delivers the converted content to the mobile device.

A key limitation of the prior art is that it does not teach a web content-creation system that allows for rapid/efficient templating, prototyping and production of rich/multimedia content for the web. Such a system would begin with a powerful file format that is rendered into HTML by a high-throughput content-creation infrastructure. Ultimately, such a system would be usable even by a lay-person. While many prior art designs are based on “scraping” full webpages or drag-and-drop website building functionality, there is no prior art that teaches content-creation by taking as input just text and then applying a collection of assets and dictionaries to give meaning to the text.

Another limitation of the prior art is that it does not teach the production of truly device-responsive multimedia content for web publishing, generated at a high throughput. While the HTML5 standard has device-responsive features, they still have to operate under traditional web publishing regimes without the high-throughput content-creation capabilities of the present design.

### OBJECTS OF THE INVENTION

In view of the shortcomings of the prior art, it is an object of the present invention to provide methods and apparatus/systems for rapid/efficient web content-creation.

It is another object of the invention to efficiently generate web content by starting with a text/textual file format that is specifically designed for high-throughput web content-creation.

It is yet another object of the invention to provide a web content-creation platform/infrastructure with a collection or database of web assets used in the generation of web content.

It is still another object of the invention to generate truly device-responsive web pages from its web content-creation platform/infrastructure.

Still other objects and advantages of the invention will become apparent upon reading the detailed description in conjunction with the drawing figures.

### SUMMARY OF THE INVENTION

The objects and advantages of the invention are secured by methods and systems for rapid or high-throughput content-creation for the world wide web (WWW). For this purpose, a novel and powerful file format named “graphicle” is introduced. A graphicle file (with a .GPE or .gpe extension) or simply a graphicle, is a text file containing sections. These sections have section names and their values. Together with their values, these sections specify the Uniform Resource Identifier (URI) parameters that are used to identify an endpoint of a web application programming interface (API/api), or simply web-api, running/hosted at the backend/server.

The client makes an outgoing call or request in the form of a Uniform Resource Locator (URL) with the desired URI parameters obtained from the graphicle file. The call identifies the endpoint of the web-api at the backend. The backend server may be a web server, or an application server that exposes the web-api via a web server over the HTTP protocol. For high volume/traffic environments, multiple backend servers and load balancing techniques known in the art may be used to host the web-api.

There is also a collection or database of web assets. Web assets include but are not limited to stylesheets, multimedia content, plugins, and various types of dynamic code. According to the main aspects of the disclosure, the graphicle file is converted/rendered into HTML code or a web page by utilizing one or more of the above web assets. This task is performed by the web-api which then serves the rendered web page at its endpoint identified by the URI parameters in the incoming HTTP call/request/URL from the client/browser.

The web page that is ultimately rendered is based on the HTML5 technology standard. Utilizing the HTML5 standard, the rendered code/web page is also truly device-responsive. Such a truly device-responsive code/web page is responsive to the actual/true size of the viewport of the device that is being used to view the HTML. This functionality is especially useful for clients running on mobile devices with varying sizes and capabilities of displays.

According to the present techniques, two main types of graphicles are supported, “dataCard” and “layoutCard”. The key difference between a dataCard and a layoutCard graphicle is the following. The “config” section of a dataCard graphicle or simply a dataCard contains Uniform Resource Identifier (URI) parameters that are required by the backend web api for filtering data from an unfiltered dataset. The filtered dataset is then used by the web_api in the rendering of the final HTML. In contrast, the “config” section of a layoutCard graphicle or simply a layoutCard contains the URI parameters which hold data that is directly used by the web_api for rendering of the final HTML without any filtering. The web_api determines the type of the graphicle from the “id” section contained in the “config” section of the graphicle and passed to the web-api as a URI parameter.

For a dataCard, the web-api at the backend server uses the URI parameters for filtering data from a full or unfiltered dataset for the named entity associated with the graphicle file. The full dataset is stored in a separate file. Preferably, the file containing the full/unfiltered dataset is based on JavaScript Object Notation (JSON) format. Thus, the web-api uses the above URI parameters as a filter on this JSON file of full dataset to obtain a filtered dataset. The filtered dataset is also preferably in JSON format.

There is a predefined HTML template associated with the endpoint of the web-api that is identified and called by the client/browser. The predefined HTML template contains the desired combination of web assets required in the rendered web page. For a dataCard, the predefined HTML template is then advantageously applied by the web-api to the filtered dataset for rendering the eventual HTML web page. For a layoutCard, the predefined HTML template is then advantageously applied by the web-api to the data directly provided to the web-api in the URI parameters of its incoming call.

The graphicle file is organized in sections. The URI parameters as well as any data related to the named entity associated with the graphicle file is stored in these sections. Preferably, the sections are semantically organized. A semantic organization of the sections makes the graphicle file more human friendly/readable, and easily allows developers to construct calls to access the backend web-api.

Preferably, the web assets consisting of stylesheets are any combination of cascading stylesheets (CSS), LESS/Less stylesheets and synthetically awesome stylesheets (SaSS). Preferably, the web assets consisting of multimedia content are any combination of pictures, animations, videos, audios, 3D elements and live-scraped data. Preferably, the web assets consisting of plugins include charts. Preferably, the web assets consisting of dynamic code include asynchronous JavaScript and XML (Ajax) libraries.

In another preferred embodiment, the web assets collection is based on a typical database technology available in the art, including but not limited to a relational database, an object database, a NoSQL database, an in-memory database, a datastore, a data mart, a database warehouse, etc.

In yet another highly preferred embodiment, the web assets collection consists of files distributed in various locations in the instant content-creation infrastructure or platform. Advantageously, there is a content management system (CMS) that is used by a user to create posts and to render the graphicle file into HTML code. In another variation, a graphicle compiler is used to compile the graphicle text file into fully rendered HTML. Preferably, the graphicle compiler is a standalone application. Preferably, the graphicle compiler is a command line application. Still preferably, the graphicle compiler has a graphical user interface (GUI), or is even a web/browser application.

The device-responsive web page generated/rendered by the above content-creation techniques is viewable in a standard web browser. Advantageously, the web page has a layout corresponding to the endpoint that was identified in the call/request/URL from the client/browser. That is because, each endpoint of the web-api at which a rendered HTML page is served, has an associated HTML template. The web-api applies this HTML template to data for rendering the web page with its associated layout. As already stated, this data may be the filtered dataset for a dataCard, or the unfiltered data directly supplied to the web-api in its incoming call/URL for a layoutCard.

Advantageously, the rendered web page has a color style based on an array of 3 or more root colors. Furthermore, the rendered web page has a text/font sizing which is based on a typography scale which uses a series of font sizes based on a ratio.

In yet another useful embodiment, the above techniques are replicated to render/convert multiple graphicle files to multiple web pages. In such an embodiment, each graphicle file has URI parameters identifying an endpoint of a respective web-api. This endpoint is accessed by the client at the backend as before. Also as before, the web-api renders a web-page corresponding to the graphicle file and serves the web page at its called endpoint. Thus, multiple graphicle files may be rendered into respective web pages in this scenario by having multiple endpoints of one or more web-api's. Obviously, the web-api's may be hosted on one or more web servers as required.

In still other variations, the web api dynamically generates the finally rendered HTML page, without the use of a predefined HTML template. Such an embodiment is useful because one can implement the web api in even more of a self-contained manner.

Clearly, the system and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 provides a high-level block diagram overview of the system of content-creation for the world wide web (WWW) according to the instant principles.

FIG. 2 illustrates a more detailed block diagram overview of the web content-creation infrastructure based on the present teachings.

FIG. 3 shows a highly detailed view of an embodiment of the content-creation infrastructure of FIG. 2 for rendering a graphicle into a web page.

FIG. 4 is a screenshot of an exemplary web page for a dataCard rendered by the instant web/WWW content-creation infrastructure.

FIG. 5 is a screenshot of an exemplary web page for a layoutCard rendered by the instant web/WWW content-creation infrastructure.

FIG. 6 shows an exemplary percentCircle layoutCard based on the instant teachings.

FIG. 7 is a screenshot of an exemplary device-responsive web page rendered by the instant content-creation infrastructure.

FIG. 8 shows some of the industry verticals or genres supported by the instant design for rapid web content-creation.

FIG. 9 shows in detail several more components of the ecosystem of the web content-creation infrastructure based on the instant principles.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

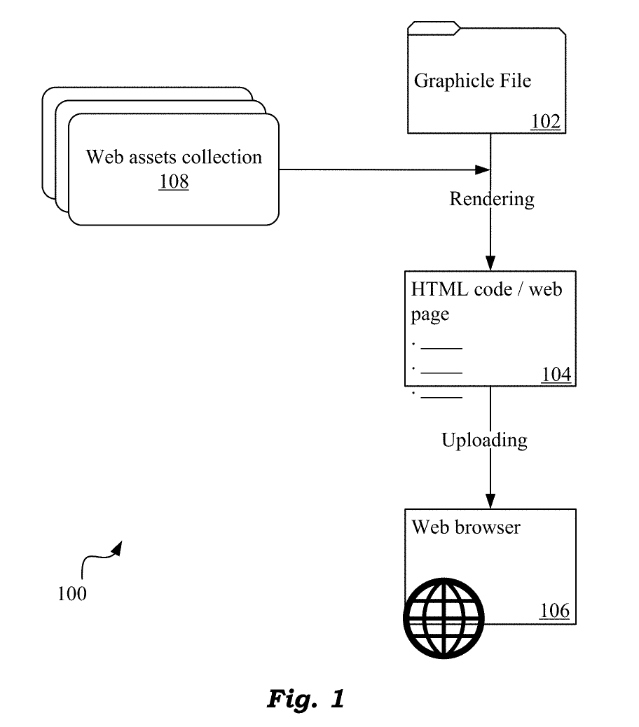

The present invention will be best understood by first reviewing a content-creation infrastructure or platform 100 for publishing of web content as illustrated in FIG. 1. FIG. 1 shows a “graphicle” file 102 that is rendered into HTML code or web page 104 which is viewable/uploadable in a browser 106. HTML code 104 is device-responsive code based on the HTML5 technology standard. A device-responsive code adapts content to best fit within the actual/true size of the viewport of the device that is being used to view the HTML. This will be explained in detail further below in this specification.

For the above rendering to take place, infrastructure 100 uses a web assets collection or simply an assets collection 108. Assets collection 108 contains a variety of static web assets required to display the HTML5 code corresponding to graphicle file 102. More specifically, collection 108 contains stylesheets, plugins and other multimedia objects such as pictures, videos, social feeds and other 3D elements and the like that will be used in the HTML5 code rendered from graphicle file 102.

Graphicle file 102 of the instant technology is a powerful text file format that is used to create browser readable HTML5 code in a fast and efficient manner. According to the instant design, graphicle file 102 is preferably an encrypted text file with a .GPE or .gpe (or some other suitable) extension. From here onwards, we may also refer to a graphicle file, such as graphicle file 102 of FIG. 1, as a GPE, .GPE, gpe or .gpe file or simply a graphicle. Obviously, the term/name “graphicle” as used in this disclosure may be substituted for some other suitable term/name or even dropped altogether without departing from the principles taught herein.

Further, we may drop the distinction between the terms HTML5 and HTML when referring to the HTML standard of an eventual web page produced by the rendering process of the present teachings. As such, and unless otherwise necessary to distinguish between HTML and HTML5, we may refer to the rendered page as being based on simply HTML or even just html (in lowercase) while understating that that the rendered web pages are based on HTML5 technology.

Similarly, when we refer to the HTML code rendered by the present technology, we mean the web page containing the HTML code that is uploadable/viewable in a web browser. As such, we may also refer to the web page(s) rendered by the instant design as simply the rendered HTML code. However, it should be noted that in some variations, the user may choose to copy and paste HTML code snippets from an instant web page that is rendered, into one or more other web pages.

Graphicle or text file 102 and associated infrastructure 100 shown in FIG. 1 are valuable for rapidly and efficiently creating prototypical and/or production quality web content at high throughput. Such creation of web content afforded by the instant technology can be accomplished with minimum user/human expertise.

Ultimately, the user may even be a lay person. Alternatively, the process can be fully automated.

Let us now look at the present web content-creation techniques in a much more detailed manner. The GPE/text file according to the present teachings, consists of one or more sections that are semantically organized. By semantic organization of these sections we mean that the sections are named and organized/arranged so as to make the GPE file more readable and user-friendly to a human user. The graphicle or GPE text file of the instant technology comes in two main varieties or types: “dataCard” and “layoutCard”.

The main difference between a dataCard and a layoutCard graphicle is the following. The “config” section of a dataCard graphicle or simply a dataCard contains Uniform Resource Identifier (URI) parameters that are required by the backend for filtering data from an unfiltered dataset. The filtered dataset is then used in the rendering of the HTML. In contrast, the “config” section of layoutCard graphicle or simply a layoutCard contains the URI parameters that contain data which is directly used for rendering of the final HTML without any filtering. As will be explained, an instant web application programming interface (API/api), or simply web-api, running at the backend/server determines the type of the graphicle from the “id” section contained in the “config” section of the graphicle and passed to the web-api as a URI parameter.

A graphicle file, whether a dataCard or a layoutCard, has one or more sections that uniquely identify a named entity to which the graphicle belongs or is associated with. These one or more sections are collectively referred to as the naming sections. Depending on the “id” parameter per above, in an exemplary implementation addressing the NBA sports vertical, these sections may be just “nba-team” to identify a team/group, or two sections “first-name” and “last-name” to identify a player/individual, or even more sections as need to uniquely identify the named entity.

The next section is “config” section containing sub-sections (or sections within the config section). As mentioned, these sections within the config section contain URI parameters related to the named entity identified above. An exemplary unencrypted or decrypted or decoded graphicle file of type dataCard is presented below:

lebron-james gpe m decoded.txt:

{// Naming sections to identify the named entity
// 1^{st} Section
“first-name”: “LeBron”,
// 2^{nd} Section
“last-name”: “James”,
// 3^{rd} Section
“config”: {“group”: “NBA”, “id”: “playerCard”, “stat-1”: “PTS”,
“stat-2”: “REB”, “stat-3”: “AST”, “theme”: “bgimg”}
}

As already stated, in a GPE file whether of type dataCard or layoutCard, the naming sections identify the named entity to which the graphicle is associated with. Specifically, as in the above dataCard graphicle for Lebron James, the first and second sections, “first-name” and “last-name” respectively are the naming sections, uniquely identifying Lebron James, the NBA player. Similarly, an exemplary unencrypted or decrypted or decoded graphicle file of type layoutCard is presented below:

tracy-mcgrady gpe n decoded.txt:

{// Naming sections to identify the named entity
// 1^{st} Section
“first-name”: “Tracy”,
// 2^{nd} Section
“last-name”: “McGrady”,
// 3^{rd} Section
“config”: {“group”: “NBA”, “id”: “playerQuote”, “text-1”: “I
didn't have a championship. I didn't have much playoff success,
but this is my championship and it'll be forever.”, “text-2”:
“Mark Berman”, “text-3”: “Fox 26”, “theme”: “dark”}}

The above graphicle files are included in the computer program listings appendix submitted herewith.

The reader will notice the above-mentioned “config” section after the naming sections in the above graphicles. Contained within the “config” section is the section “id” which identifies to the backend web-api the exact card to be generated for the graphicle. For example, graphical file lebron-james_gpe_m_decoded.txt is instructing the web-api to generate a playerCard for Lebron James by utilizing the various URI parameters specified in the graphical.

Similarly, graphical file tracy-mcgrady_gpe_n_decoded.txt is instructing the web-api to generate a playerQuote for Tracy McGrady by utilizing the various URI parameters specified in the graphicle. The “_m_” and “_n_” in the filenames above are simply indicative of the fact that many such graphicle files may be associated with Lebron James and Tracy McGrady, each with different URI parameters.

It should be noted that the ordering of sections as presented above is simply a grouping or structure of the GPE file that is more human-friendly and readable than otherwise. Furthermore, the naming of the sections is also human-friendly and intuitive. This naming is understood by the infrastructure according to its own dictionary or meanings/functionality associated with each section name as discussed throughout this disclosure.

The naming and ordering of sections of the GPE file, which we refer to as semantic organization or ordering, does not impose any technical restrictions on the functionality of the graphicle. In other words, the sections of a GPE file may also be placed in any sequence/order, random or otherwise, without loss of functionality of the present techniques. Similarly, the sections may be named differently, so long as each section has a unique name.

Also shown in the above GPE files are the value portions or contents of each section. Specifically, the first section in the above dataCard is “first-name” whose value is “LeBron”, the second section is “last-name” whose value is “James” and so on. The skilled reader will have noticed that the format of the above provided GPE files is reminiscent of arrays and arrays of arrays in JavaScript Object Notation (JSON). The entire GPE file can be seen as an array, whereas “config” sections of dataCard and layoutCard are arrays within the array.

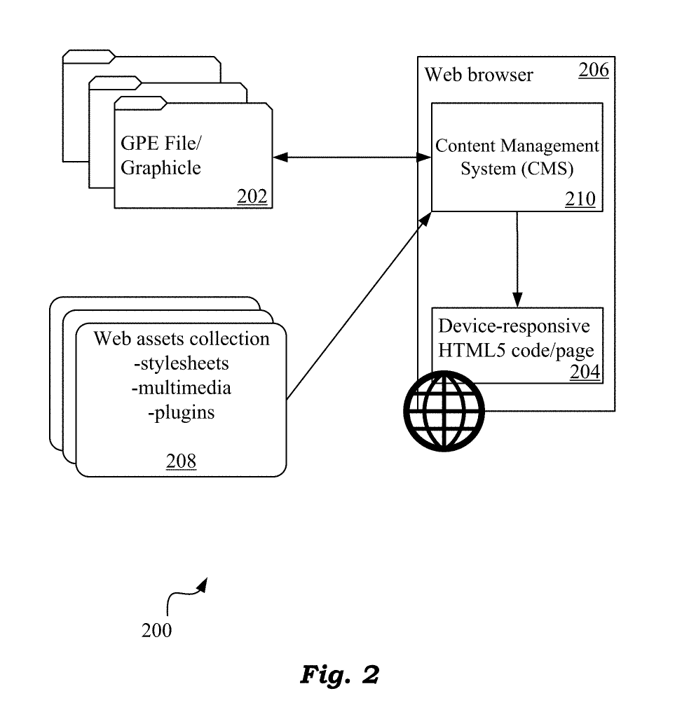

Let us now look at FIG. 2 which sheds more light onto the process of rendering a GPE file into a corresponding HTML web page. Based on the instant techniques, FIG. 2 shows a web content-creation infrastructure or platform 200 containing a content management system (CMS) 210. Also referred to as a Content Engine, CMS 210 is an application used for the creation/maintenance of the content for the world-wide web according to the teachings disclosed herein. The output from CMS 210 is available as “posts” which are the web pages that are uploadable/viewable in web browser 206. Note that CMS 210 is a web application and hence it runs in web browser 206 as shown in FIG. 2.

Note also that GPE file 202 may be more than one file as shown, although for ease of explanation, some of the present teachings may be provided by using examples where a single GPE file/graphicle is rendered/converted into its correspondent web page. The skilled reader will easily be able to apply the same teachings for rendering multiple GPE files or graphicles as will be provided herein.

As already mentioned, the HTML code generated by infrastructure 200 is a device-responsive code based on HTML5 standard.

Infrastructure 200 further includes an assets collection 208. Collection 208 in reality simply refers to a loose collection of static web assets. Such web assets may be stylesheets of various types, plugins of various types, multimedia content of various types and dynamic code of various types, and located as files in semantically organized directories in infrastructure 200. By semantically organized directories, here also we mean that the web assets are stored in directories that have logical and intuitive names for a user to remember.

Alternatively, collection 208 may be a conventional database based on one or more of the many database technologies available in the art. These include but are not limited to relational databases, object databases, NoSQL databases, in-memory databases, various types of database warehouses and data marts, etc.

Web assets include stylesheets, including but not limited to cascading stylesheets (CSS), LESS or Less stylesheets, synthetically awesome stylesheets (SaSS), etc. They also include multimedia content including but not limited to static photos (in PNG, JPG, TIFF, or any other suitable format/standard available in the art), animations (in GIF, SVG, MPEG, AVI, or any other suitable format/standard available in the art), live-scraped data (social feeds, counters), videos (in AVI, FLV, WMV, MOV, MP4 or any suitable format/standard available in the art), audios (in PCM, WAV, AIFF, MP3, AAC, WMA or any other suitable format/standard available in the art), 3D elements (360 videos, CSS3 mixins), etc.

Web assets in collection or database 208 also include various plugins, including but not limited to charts, data visualizations, animations, and other plugins usually provided as a JavaScript plugin. JavaScript plugins may also include various types of dynamic code, such as Asynchronous JavaScript and XML (Ajax) libraries. Finally, web assets may also include any other type of web assets not listed above within the scope of the instant principles.

In the preferred embodiment, a plaintext or decrypted/decoded graphicle file such as lebron-james_gpe_m_decoded.txt graphicle file presented above, is first coded/ciphered to lebron-james_gpe_m.gpe file (with the designated .GPE or .gpe extension for a graphicle) prior to local storage. Similarly, tracy-mcgrady_gpe_n_decoded.txt graphicle file is coded/ciphered to tract-mcgrady_gpe_n.gpe file prior to local storage. The ciphering process will be explained in detail further below in this disclosure.

As already mentioned, a graphicle file such as the above provided exemplary graphicle files lebron-james_gpe_m_decoded.txt and tracy-mcgrady_gpe_n_decoded.txt, consist of semantically organized sections. By a semantic organization of the sections, we mean that the names and groupings of the sections make the GPE file format human friendly/readable allowing developers to easily construct calls to respective endpoints. An end-user can easily edit/maintain such a file. Therefore, it is conceived that with some familiarity with the graphicle file format and the web content-creation infrastructure taught herein, even a lay-person will be able to publish web content at high throughput. Such a process can even be fully automated.

The above exemplary graphicle files contain naming sections “first-name” and “last-name” to uniquely identify the named entity associated with the graphicle file, for example, the NBA player Lebron James. These as well as the other sections of the graphicle file embody the URI parameters which are used to construct calls by a client application to specific endpoints of the web-api running at the backend/server. The calls are constructed as Uniform Resource Locator (URL's) to the back-end web-api or “controller”. The URL contains the URI parameters contained in the sections of the original graphicle file.

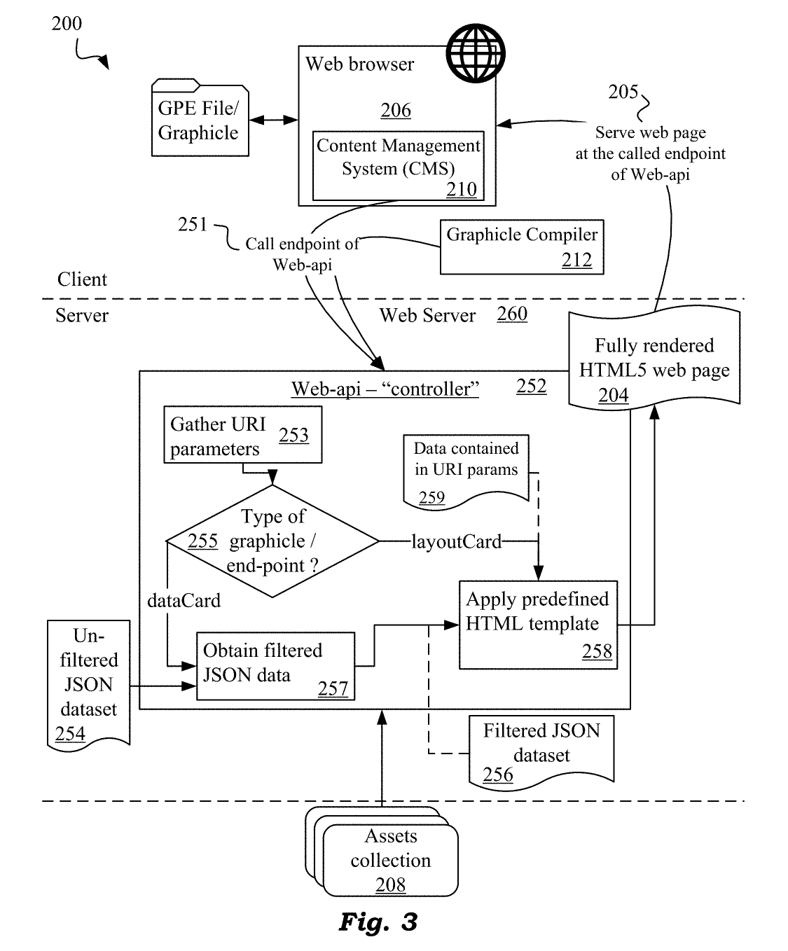

The URI parameters may be passed literally into the URL constructed by the client application and/or they may get substituted for call variables as will be explained further below. The controller code implementing the web-api then parses the URL to first gather/collect these URI parameters and then uses them to render the final HTML which it then serves at its originating or called endpoint. This process is illustrated in FIG. 3 for rendering html from a graphicle of type dataCard or layoutCard.

As a part of its implementation, the controller code uses the first set of sections from the original graphicle file which were passed to it as URI parameters, in the present case “first-name” and “last-name”, to uniquely identify a named entity. It is this named entity to which the original graphicle file is associated with and for which the web-api will render the final HTML.

As shown in FIG. 3, a call 251 to an endpoint of web-api 252 running on web server 260 is in the form of a URL containing various URI parameters per above explanation. This URL call is constructed by a client application of the instant infrastructure. The client application may be a CMS 210 which is a web application as shown, or it may be a standalone application called Graphicle Compiler 212 as shown. Graphicle Compiler 212 may be a command line application or it may be a Graphical User Interface (GUI) based application. An exemplary URL call 251 created by CMS 210 or Graphicle Compiler 212 to web-api 252 correspondent to above graphicle file lebron-james_gpe_m_decoded.txt is:

http://www.explica.co/nba/players/playerCard/lebron-james?stat1=
PTS&stat2=REB&stat3=AST&theme=bgimg

Rather than relying on specific domain names for various implementations of the instant design, from here onwards we will employ the more general notion of relative paths/URL's “ . . . ” to specify such calls and URL's. This generic notation will be familiar to skilled artisans. For example, we will specify the above URL as simply . . ./playerCard/lebron-james?stat1=PTS&stat2=REB&stat3=AST&theme=bgimg.

The above call/URL 251 identifies an endpoint named playerCard of web-api 252. As shown in FIG. 3 that in response to above URL/call 251, web-api 252 first collects the URI parameters from the incoming call. This is shown by process/function box 253. Next, web-api 252 determines whether the called endpoint is for a dataCard or a layoutCard. This is indicated by decision diamond 255. For this decision, web-api 252 looks at the “id” parameter passed to it in incoming call/URL 251.

Following is a partial list of the various types of cards supported by the instant infrastructure. For each card provided below, there is a corresponding endpoint of web-api 252 with the same name.

TABLE 1
Exemplary cards supported by the instant
techniques in the NBA vertical

| Vertical | Type of card | “id” of Card |
|---|---|---|
| NBA | dataCard | playerCard |
| NBA | dataCard | gameCard |
| NBA | dataCard | teamRecord |
| NBA | dataCard | scheduleCard |
| NBA | dataCard | careerCharts |
| NBA | dataCard | versusGraph |
| NBA | dataCard | shotCharts |
| NBA | dataCard | iconBars |
| NBA | dataCard | playerLeader |
| NBA | dataCard | teamVersus |
| NBA | layoutCard | playerQuote |
| NBA | layoutCard | percentCircle |

dataCard Example:

Thus, if the called endpoint as determined by “id” parameter of incoming call/URL 251 is for a type of card that is a dataCard, web-api accesses an unfiltered or full dataset 254 for the named entity specified in call/URL. This is indicated by the outcome on the left coming out of decision diamond 255.

In the present example, starting from the original graphicle file of lebron-james_gpe_m_decoded.txt, the named entity specified in call/URL 251 is Lebron James, and the graphicle and the specific dataCard instructed to be generated is a playerCard (as specified in the “id” parameter). In the preferred embodiment, data in unfiltered dataset 254 stored for the specified named entity is in the format of JavaScript Object Notation (JSON). This is done by utilizing object arrays of JSON. Web-api 252 determines the location of the JSON file by constructing another URL based on the specified named entity. This URL points to another convenient location on the same server or some other server on the internet.

In an exemplary implementation of the instant techniques, the URL constructed by web-api 252 for accessing unfiltered JSON dataset file 254 for Lebron James is . . . /nba/stats/players/lebron-james.json. The abbreviated contents of an exemplary unfiltered JSON dataset file are provided below.

This file is included in the computer program listings appendix as lebron-james_json.txt.

lebron-james.json

```
        [{ “first-name”: “LeBron”,
            “last-name”: “James”,
            “nba-position”: “Forward”,
            “draft-round”: “1”,
            “draft-pick”: “1”,
            “draft-year”: “2003”,
        “accent”: “#8B0034”,
        “accent-2”: “#F9B433”,
        “nba-weight”: “250”,
        “nba-height”: “6-8”,
        “shot_chart”: {
                “in-the-paint-nonra”: 0.393,
                “midrange”: 0.362,
                “restricted-area”: 0.761,
                “above-the-break-3”: 0.362,
                “backcourt”: 0.0,
                “left-corner-3”: 0.435,
                “right-corner-3”: 0.294
        },
        “season”: {
                “REB”: 8.6,
                “FG3A”: 4.6,
                “FGA”: 18.2,
                “FGM”: 9.9,
                “FTM”: 4.8,
                “BLK”: 0.6,
                “STL”: 1.2,
                “PF”: 1.8,
                “FG_PCT”: 0.548,
                “FG3_PCT”: 0.363,
                “OREB”: 1.3,
                “TOV”: 4.1,
                “FTA”: 7.2,
                “AST”: 8.7,
                “PTS”: 26.4,
                “FT_PCT”: 0.674,
                “DREB”: 7.3,
                “FG3M”: 1.7
        },
        “historical”: {
                “season”: {
                    “REB”: [5.5, 7.4, 7.0, 6.7, 7.9, 7.6, 7.3, 7.5,
7.9, 8.0, 6.9, 6.0, 7.4, 8.6],
                    ...
            },
            “career”: {
                    “REB”: 7.3,
                    “FG3A”: 4.0,
                    “FGA”: 19.6,
                    ...
            }
    },
    “nba-team”: “Cleveland Cavaliers”,
    “nba-number”: “23”}
```

In a related variation, unfiltered dataset file may be stored in eXtensible Markup Language (XML) or some other convenient notation available in the art. The unfiltered dataset, whether in JSON or other formats, is typically stored on server 260. However, it can also be stored on some other server accessible via a URL over the internet.

In a useful embodiment suitable for offline/local deployment of the instant techniques, the unfiltered dataset file is stored locally on the same machine as the client. For example, the file may be stored on a local client drive or a shared drive on a local area or remote area network that is not necessarily connected to the internet. In other variations, the file may also be served locally by a localhost. Such an offline embodiment is useful during the development/testing phases of a software development cycle, as will be recognized by skilled artisans.

In any case, and continuing with the flow depicted in FIG. 3, web-api 252 then applies URI parameters from “config” section of the graphicle file to filter data from full/unfiltered JSON dataset file 254. Recall that these URI parameters were passed to web-api 252 in incoming call/URL 251 . . . /playerCard/lebron-james?stat1=PTS&stat2=REB&stat3=AST&theme=bgimg.

This filtering process is shown by box 257 in FIG. 3 and the resultant filtered JSON data is marked by reference numeral 256.

The abbreviated contents of filtered dataset 256 from the above-provided abbreviated unfiltered dataset 254 in the present example are presented below. The filtered data contains the statistics of points (PTS), rebounds (REB) and assists (AST) requested for Lebron James in the original graphicle lebron-james_gpe_m_decoded.txt.

Filtered dataset 256 for Lebron James

```
[{“first-name”: “LeBron”,
    “last-name”: “James”,
    “nba-position”: “Forward”,
    “nba-team”: “Cleveland Cavaliers”,
    “nba-number”: “23”,
    “season”: {
          “REB”: 8.6,
          “AST”: 8.7,
          “PTS”: 26.4
    },
    “historical”: {
          “season”: {
              “REB”: [5.5, 7.4, 7.0, 6.7, 7.9, 7.6, 7.3, 7.5, 7.9, 8.0,
6.9, 6.0, 7.4, 8.6],
              “PTS”: [20.9, 27.2, 31.4, 27.3, 30.0, 28.4, 29.7, 26.7,
27.1, 26.8, 27.1, 25.3, 25.3,26.4],
              “AST”: [5.9, 7.2, 6.6, 6.0, 7.2, 7.2, 8.6, 7.0, 6.2, 7.3,
6.3, 7.4, 6.8, 8.7]
          },
          “career”: {
              “REB”: 7.3,
              “PTS”: 27.1,
              “AST”: 7.0,
          }
    }
}
```

Note that the filtered JSON dataset 256 above also contains data for sections “nba-position”, “nba-team” and “nba-number” even though these sections were not contained in the original graphicle file lebron-james_gpe_m_decoded.txt. This is because, besides “first-name” and “last-name”, web-api 252 needs these fields to properly identify the predefined HTML template to apply to dataset 256.

In other words, each playerCard for a given team as specified by “nba-team” section, will have its own background colors and layout. Then “nba-position” and “nba-number” sections further identify the exact picture for Lebron James with his NBA Number. As a result, the exact predefined HTML template is selected by web-api 252 to apply for generating the playerCard for Lebron James. A similar scheme may be employed in the present infrastructure for other types of web pages besides playerCard and for other industry verticals/genres besides NBA.

Next, web-api 252 applies the predefined HTML template to filtered JSON dataset 256 as indicated by process box 258. This results in a fully rendered HTML5 web page 204 correspondent to the original lebron-james gpe m decoded.txt graphical file. Rendered and final web page 204 is served at the specified endpoint of playerCard called by originating/incoming call 251 to web-api 252. This is shown by arrow marked by reference numeral 205. The final web page is viewable in browser 206.

layoutCard Example:

Referring again to decision diamond 255 of FIG. 3, if the called endpoint as determined by “id” parameter of incoming call/URL 251 is for a card of type layoutCard, this outcome is indicated by the outcome on the right coming out of decision diamond 255. In the present example, starting from the original graphicle file of file tracy-mcgrady_gpe_m_decoded.txt, the named entity specified in call/URL 251 is Tracy McGrady, and the specific dataCard instructed to be generated is a playerQuote. Incoming call/URL 251 for this layoutCard example will look as follows in an exemplary implementation:

. . . /playerQuote/tracy-mcgrady?“text-1”: “I didn't have a championship. I didn't have much playoff success, but this is my championship and it'll be forever. ”&“text-2”: “Mark Berman”& “text-3”: “Fox 26”&theme=dark

Since there is no filtering done for a layoutCard, data 259 provided in the URI parameters of incoming call/URL 251 is directly used by process/box 258 to render final HTML page 204. Finally rendered page 204 is again served at the called endpoint of playerQuote of web-api 252. As before, the final HTML web page is viewable in browser 206.

FIG. 3 shows CMS 210 running in browser 206 and making client-side request/call/URL 251 to web-api 252 running on the server-side. As noted, call 251 contains the specific URI parameters required to render a web page. Note that in other variations, any web application other than CMS 210 in browser 206 may be used to interact with web-api 252 at the backend to convert a graphicle file into HTML. As already noted, one such application is graphicle compilter 212.

In any case, web-api 252 is hosted on a web server 260. For efficiency reasons, web server 260 is static or cookie-less. This is preferred where assets collection 208 is a collection of files in various semantically organized directories in the infrastructure or for offline deployments on local (client) machines. Recall from above that for such offline/local deployments, unfiltered JSON dataset 254 is also stored locally on the client machines or on a network that is not necessarily connected to the internet.

Web server 260 may be implemented using any number of web server technologies available in the art. These include but are not limited to Microsoft Internet Information Services (IIS) server, Apache web server, Digital Ocean (DO), Google Web Server (GWS), IBM HTTP Server, Oracle HTTP Server, Oracle WebLogic Server, etc. Furthermore, there may be more than one web servers 260 installed to support high traffic volumes. An associated load balancer may also be used.

The techniques for architecting high volume websites (such as Amazon.com, Google.com, etc.) with multiple web servers, load balancers and databases are well known in the industry and not delved into detail in this specification. The skilled artisans will further realize that in many practical situations, the system will incorporate an n-tier design where n is >=3. In other words, in many situations, an application server will house the business logic that will be exposed by the web server to the client as HTTP traffic.

In the present case, an application server is where web-api 252 of FIG. 3 may be implemented/hosted. Furthermore, the application server typically interacts with a database to execute its business logic. Again, such web systems design and architectural techniques have been known in the art for decades and not delved into detail in this specification. The skilled reader will further recognize that the terms web server and application server are oftentimes used interchangeably in the art.

For the above reason and also to avoid detraction from the core principles taught herein, we will simply refer to the computing backend of the present infrastructure as a web server in this specification and the accompanying drawing figures. We will however appreciate the various practical design choices mentioned above available to those skilled in the art for precisely building the backend.

As taught above, URI parameters “first-name” and “last-name” correspondent to the respective naming sections in the GPE file identify the named entity of Lebron James. In the “config” section, we have already discussed the significance of the “id” section or sub-section. To repeat, “id” parameter is used to identify the exact card for rendering by the web api and to select the corresponding HTML template for rendering the eventual web page. The application of HTML template will be explained further below.

Next, “group” section in the “config” section specifies that data being accessed is for the NBA vertical/genre. “group” parameter is useful because the present web content-creation techniques may be applied in several verticals, including other sports, such as National Football Association (NFL), entertainment industry including music and movies, finance industry, etc.

Thus, “group” parameter can be used in the URL of call 251 to web-api 252 to properly locate the endpoints for various industry verticals. In other words, the resources accessed via the URI parameters in calls 251 may be segregated at the server based on the industry vertical. Then, a properly constructed URL can be used to access the resources related to the requisite industry vertical.

For a dataCard, URI parameters “stat-1”, “stat-2” and “stat-3” specify the NBA statistics to be retrieved from unfiltered/full JSON dataset 254 containing the NBA statistic of Lebron James (see FIG. 3). Finally, “theme” parameter specifies the background image to apply to the eventual HTML page. A filtered dataset 256 is obtained from full JSON dataset 254. Filtered dataset 256 is then applied by web-api 252 to populate a pre-defined HTML template identified by the “id” parameter. This is indicated by process/box 258 which is explained further below.

Conversely for a layoutCard, such as playerQuote, various text fields provide the data required to generate the layoutCard. In the above layoutCard example, “group” and “id” sections/parameters serve the same purpose as a dataCard. “text-1”, “text-2” and “text-3” fields provide specific data contained in these URI parameters and shown by reference numeral 259 in FIG. 3. Specifically, for a playerQuote, these three fields provide the text of the quote, the sports pundit who communicated/conveyed it, and the source of the quote. This data is used by process/function box 258 as will be explained below.

The reader should observe that many other types of layoutCard are conceivable using this scheme, so that any number of text fields may be sent as URI parameters in call/URL 251 to generate any desired card.

In any event, process/function box 258 of web-api 252 applies a predefined HTML template to either filtered dataset 256 or data directly gathered from the URI parameters 259. It uses the “id” parameter to determine which specific HTML template is to be used. In the present examples, the HTML template being selected is for a playerCard or a playerQuote. Recall that a playerCard is generated from a graphicle of type dataCard as taught above, and playerQuote is generated from a graphicle of type layoutCard. The end result of process 258 of the application of playerCard HTML template is a fully rendered web/HTML page 204 containing any necessary embedded tags.

The HTML template chosen by process/function 258 contains or references the desired combination of above taught web assets from assets collection 208 to render web page 204. Rendered web page 204 is ultimately served at the endpoint that was used to call web-api 252. The serving of the resulting HTML/web page in response to call/request/URL 251 to web-api 252 is marked by reference numeral 205 in FIG. 3. As already noted, page 204 is viewable in a standard web browser 206 available in the art.

In a related variation, process 258 is separated out from web-api 252 into a separate server-side application. In such a variation, based on the resources or URI parameters specified in call/URL 251, web-api 252 obtains filtered dataset 256 (for a dataCard) or data 259 contained in URI parameters (for a layoutCard), and stores it into another file on the server. This file is then accessed by the above separate server-side application for applying to or populating the HTML template identified by “id”. This process then generates the fully rendered web page 204.

As noted earlier, assets collection 208 may be a contemporary database such as a relational or no-sql database (such as MongoDB) or even an object database. This is typically useful when it is the content management system or a live preview editor, that is the client application being used. In such embodiments, “posts” created by CMS 210 or a live preview editor can be protected into a conventional database so as to prevent any unauthorized access or tempering. As already noted, that otherwise assets collection 208 is preferably a collection of files organized in semantically named directories.

By semantically named directories, we mean directories having names that are human friendly, that is, have logical names that are easy to remember by users. Such a collection of files may be spread across the internet, or alternatively, may be stored locally for offline development and deployment. Obviously, it is conceivable that some of the web assets may be available locally while others are available remotely on the internet. The skilled artisan will appreciate the various development and deployment regimes that may be used in the practice of instant principles.

Browser 206 should support key features of HTML5 as required by the instant techniques. Due to continually evolving CSS & HTML standards since 1996 and as set by World Wide Web Consortium (W3C), browser support for these features includes support for CSS3 features, SVG graphics, drag-and-drop and touch devices.

Popular choices for browser 206 include but are not limited to Google Chrome 15, Mozilla Firefox 8, Internet Explorer 9, Safari 9.0, Microsoft Edge 11.1, Opera 12, etc. Obviously, any later versions of the browsers than the ones listed above are also possible.

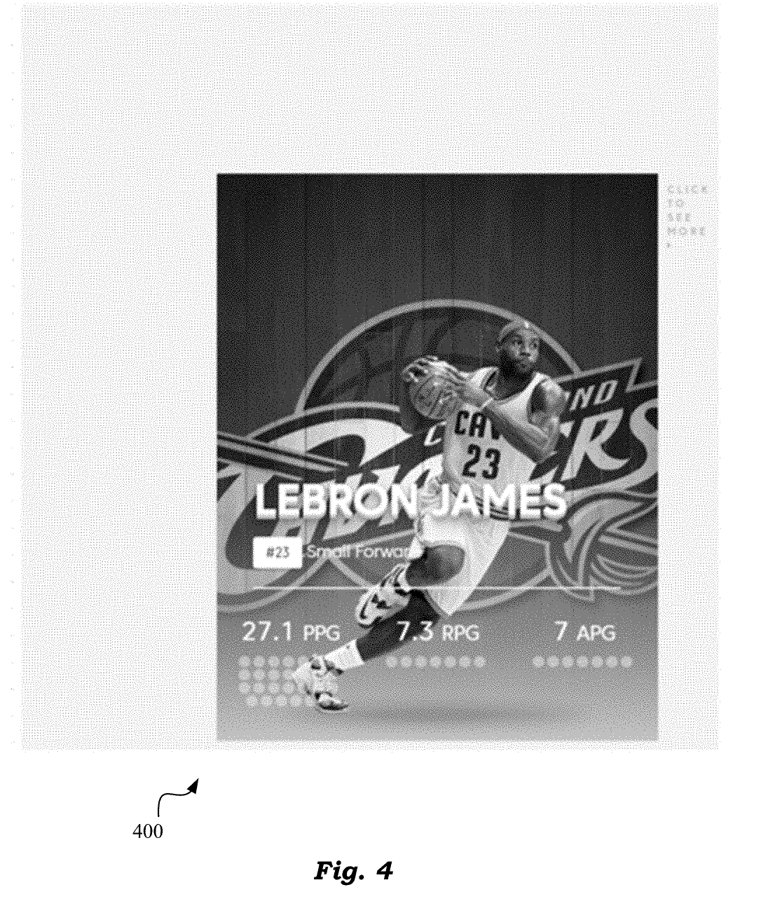

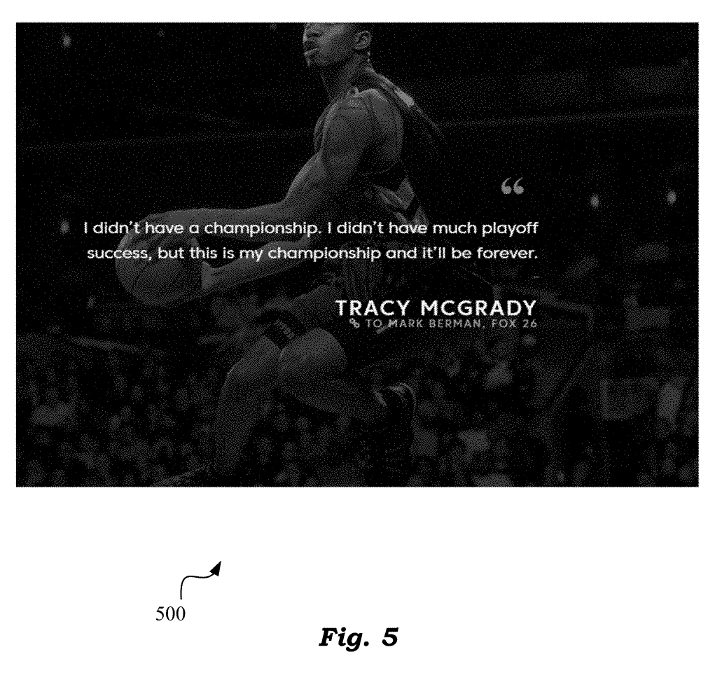

FIG. 4 and FIG. 5 show the fully rendered HTML/html pages 400 and 500 corresponding to the above GPE files lebron-james_gpe_m_decoded.txt and tracy-mcgrady_gpe_m_decoded.txt. Web page 400 of FIG. 4 shows the statistics for Lebron James as specified in the URI parameters. Specifically, web page 400 shows PTS (points), as PPG (points per game), REB (rebounds) as RPG (rebounds per game) and AST (assists) as APG (assists per game).

Based on the instant principles, one can thus use the powerful graphicle format to render aesthetically looking web pages in an efficient manner. In the preferred embodiment, the layout for playerCard as shown in FIG. 4 has a hover-toggled animation and stops growing at a maximum width of approximately 500 pixels. The finally rendered HTML files lebron-james_playerCard html.txt and tracy-mcgrady_playerQuote_html.txt corresponding to FIG. 4 and FIG. 5 respectively, are contained in the computer program listings appendix submitted herewith.

As will be clear by now, that the instant web content-creation infrastructure provides for any number of endpoints of controller or web-api 252 of FIG. 3 to generate various types of HTML pages. For each such endpoint, a corresponding predefined HTML template containing/referencing the requisite web assets is applied to render the eventual HTML page 204 per above explanation. These endpoints along with their respective predefined HTML templates are further organized into different styles/layouts of the final HTML. Thus, “theme” URI parameter in the above-presented graphicle files and contained in incoming call/URL 251, tells web-api 251 as to which style/layout to apply to eventual web page 204.

In a similar manner, call variables in the URL may be used to further specify the selection of an endpoint. An exemplary URL for call 251 may include . . . /player[$layout]/ . . . where $layout variable is used to selected a specific layout. The eventual URL call, after variable substitution, would then include . . . /playerBanner/ . . . Exemplary values that variable $layout can take include “Banner”, “Simple”, “Card”, “Sheet”, “Score”, etc.

Thus, many variations of different types of web pages of various layouts may be generated using the present techniques.

By applying such a scheme, exemplary endpoints and HTML templates therefore include playerBanner, playerSimple, besides playerCard as in earlier examples. Similarly, other endpoints and HTML templates include teamCard, gameSheet, gameScore, gameLeaders, etc. As already mentioned, the present teachings admit of any number of such endpoints and their corresponding predefined HTML templates, for any number of industry verticals in different genres, including fashion, finance, etc. that can be supported by the instant content-creation infrastructure for the world wide web (WWW).

Explained further, by utilizing the powerful instant GPE graphicle file format, the present web content-creation infrastructure is able to efficiently produce web pages utilizing a variety of web assets and having a variety of layouts and for a variety of industry verticals. For example, and continuing with the NBA vertical, aside from a playerCard, the present web content-creation infrastructure also supports the generation of a web page in a “banner” layout.

Recall from above teachings that the layout of a playerCard as provided in the examples of FIG. 4 has a hover-toggled animation and stops growing at a maximum width of approximately 500 px. Sometimes such a card layout is also referred to as a “sheet”. Thus, in alternate variations, a playerSheet endpoint instead of a playerCard is implemented along with the rest of the above taught functionality for rendering a web page or player sheet with the above layout.

In contrast to a playerCard or playerSheet layout, a banner always fills the full-width of the screen and has a fade animation. A fully rendered web page in a banner layout is produced by web-api 252 of FIG. 3 with an endpoint called playerBanner, and by applying the above teachings for the generation of the eventual web page in the layout of a banner. Similarly, a “simple” layout has a layout that is transparent, with fade animation and one statistic field. Thus, corresponding endpoint of web-api 252 of FIG. 3 is playerSimple. Using such a flexible scheme, a large variety of web pages of various types and layouts can be rapidly produced, starting from the powerful graphicle file format.

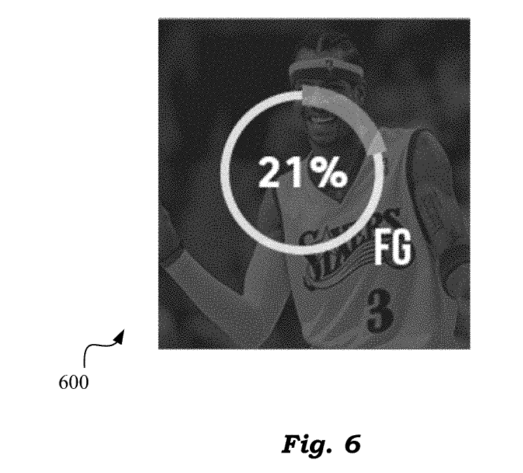

Let us see another example of a layoutCard besides playerQuote rendered in FIG. 5 and generated from the graphicle file tracy-mcgrady_gpe_n_decoded.txt. Such a layoutCard is a percentCircle, in which a percentage number is simply conveyed as data contained in URI parameters 259 to web_api 252 of FIG. 3 to display as a percent circle associated with the named entity specified in the graphicle. FIG. 6 shows an exemplary percentCircle layoutCard 600 based on the above techniques.

In the preferred embodiment, the web-api call URL is provided by . . . /player[$layout]/[$nameSlug]?[ . . . ], where the named entity is specified by [$nameSlug]. This slug value is generally determined by a script to URL-encode the string name for the individual named entity into lowercase. In such a scheme, URL encoding removes restricted characters and replaces spaces with dashes or hyphens. For instance, an exemplary call to display a banner for Lebron James would include . . . /playerBanner/lebron-james.

A multitude of endpoints may be served by a single complex web-api 252 of FIG. 3. The calls to the web-api then utilize variables in the URL that are populated by various URI parameters set at the client-side for identifying individual named entities associated with the respective endpoints at the server. Similarly, a multitude of named entities and their respective endpoints may be identified by their URI parameters in a single graphicle file or multiple graphicle files.

Though not required, there may be a one to one correspondence between a graphicle file, the endpoint identified by the URI parameters in the graphicle file and the web-api it belongs to, the predefined HTML template applied by the web-api and the web page rendered as a result. Furthermore, the rendered instant web page or web pages may be published to another web server which may serve it/them over HTTP in response to its own client requests/calls. The skilled artisan will appreciate the variety of environments, arrangements and implementation design choices by which the present principles may be practiced.

The following code snippet provides an exemplary JavaScript code of controller or web-api 252 of FIG. 3 with endpoint playerCard of the above example. This code is contained in file main_js.txt in the computer program listings appendix of this application and reproduced below to facilitate explanation. We will refer to this code as playerCard_api.js to precisely indicate that it implements the playerCard endpoint with its corresponding playerCard HTML template.

However, in a larger context, we may also refer to it as web-api 252 of FIG. 3 to generalize that similar controller code exists for other endpoints of web-api 252, each with a corresponding HTML template. The code for several controllers based on the present techniques is contained in main_js.txt file of computer program listings appendix. Per above explanation, these endpoints include, but are not limited to, playerBanner, playerSimple, teamCard, gameSheet, gameScore, gameLeaders, etc. as well as the exemplary cards listed in Table 2 above.

The reader is further advised that even though web-api 252 of the instant design is implemented in JavaScript, it is indeed a backend/server api and deployed on a node of MongoDB, Express.js, AngularJS, and Node.js (MEAN) stack. However, the instant principles admit of any other suitable deployment stack for the implementation of the present design.

playerCard api.js - excerpted from main.js

```
        app.controller(‘PlayerCardCtrl’, function ($scope, $location,
        $http, $sce) {
          console.log(“Player Card Controller reporting for duty.”);
            $scope.$watch($location.search( ), function( ) {
                $scope.stat1 = ($location.search( )).stat1;
                if (typeof ($location.search( )).stat1 ===
                ‘undefined’) {
                    $scope.stat1 = ‘pts’;
                }
            }, true);
            $scope.$watch($location.search( ), function( ) {
                $scope.stat2 = ($location.search( )).stat2;
                if (typeof ($location.search( )).stat2 ===
                ‘undefined’) {
                    $scope.stat2 = ‘reb’;
                }
            }, true);
            $scope.$watch($location.search( ), function( ) {
                $scope.stat3 = ($location.search( )).stat3;
                if (typeof ($location.search( )).stat3 ===
                ‘undefined’) {
                    $scope.stat3 = ‘ast’;
                }
            }, true);
            $scope.$on(‘ngRepeatDone’, function( ){
                console.log(‘Ng-Repeat is done’);
            });
          var playerDash = $location.path( ).replace(‘/playerCard/’,‘’);
        $http.get(‘http://explica.co/nba/stats/players/’+playerDash+
        ‘_2016-17.json’)
            .then(function(res){
              $scope.player = res.data;
              window.data = res.data;
              $scope.youtube =
        $sce.trustAsResourceUrl(‘https://www.youtube.com/embed/’+
        $scope.player[0][‘youtube-
        slug’]+‘?fs=0&modestbranding=1&showinfo=
        0&iv_load_policy=3&controls=1&color=white’);
            });
          $scope.toDash = function(obj){
            return obj.replace(/\s+/g, ‘-’).toLowerCase( )
          };
          $scope.toSlug = function(obj){
            return obj.replace(/\s+/g, ‘_’).toLowerCase( )
          };
        // “what?” version ... http://jsperf.com/diacritics/12
        $scope.removeAccents = function(obj){
            return obj.replace(/[\hat{ }\u0000-\u007E]/g, function(a){
              return diacriticsMap[a] || a;
            });
        }
      // Activates Tooltips for Social Links
      $(‘.tooltip-social’).tooltip({
        selector: “a[data-toggle=tooltip]”
      })
    });
```

Web-api 252 is a representational state transfer (REST) or RESTful API. Internally, web-api live-scrapes statistical data from a data source such as the public API of NBA.com. Such live-scraping functionality will be known to those skilled in the art and not explicitly delved into in this specification. The web-api then stores the data in JSON format using a semantically organized structure. In other variations, and as already noted, the data may be stored in some other format than JSON, for example, XML.

The above implementation of playerCard api.js and more generally web-api 252, utilizes the AngularJS JavaScript framework. As will be appreciated by those skilled in the art that AngularJS is an open-source front-end web application framework based on JavaScript for supporting web applications that are single page applications (SPA). It is a fully client-side framework and addresses some of the challenges encountered in developing single-page applications. However, the present teachings admit of any other capable web development framework without departing from its principles. These include React.js, Amber.js, Meteor.js, Aurelia.js and Vue.js.

As evident from the above source code, web-api 252 of playerCard endpoint implements a controller with the name ‘PlayerCardCtrl’ within the model-view-controller paradigm of AngularJS. The controller first collects URI parameters, referred to by box 253 in FIG. 3 from incoming calls 251 from the client-side. It then stores them in the $scope object of AngularJS as evident from the above code. As also evident from the code, it then utilizes the $http service of AngularJS, specifically its .get method to obtain a response from the server containing filtered dataset 256 of FIG. 3.

For this purpose, the controller first constructs a URL specifying the exact JSON file to be accessed to obtain the statistical data asked via routeParams service and specifically, routeParams.stat1, routeParams.stat2 and routeParams.stat3 parameters/arguments. Recall stat-1, stat-2 and stat-3 URI parameters from the above explanation. These directly correspond to routeParams.stat1, routeParams.stat2 and routeParams.stat3 respectively. Thus, $routeParams is set at the client side before calling the controller by call/request 251 of FIG. 3. This is accomplished by a JavaScript statement such as the following, which also sets remaining URI parameters “group”, “id” and “theme” in routeParams.
$routeParams==>{group: ‘NBA’, id: ‘playerCard’, stat-1:‘stat1’, stat-2:‘stat2’, stat-3:‘stat3’, theme:‘bgimg’}

Other parameters/arguments to the controller, including AngularJS services $scope, $location, $http, $sce will be known to those familiar with AngularJS and will not be delved into detail in this specification. Similarly, the rest of the code of playerCard_api.js contains functions for translating white spaces and adjusting the alphabetical case so that the JSON data file can be correctly accessed. These functions, specifically toDash( )nd toSlug( )will be self-evident to skilled artisans from the above code. The code further removes diacritics/accents and special characters via function removeAccents( )

As already noted, $nameSlug variable is used in this exemplary implementation to unambiguously identify a named entity by its name in a standardized manner. This is done by removing all commas, periods, special characters and diacritics from its name, and replacing all spaces with dashes “-”. Therefore, the nameSlug for a variable value ‘Kyrie Irving’ will be ‘kyrie-irving’, and for ‘lebron James’, it will be ‘lebron-james’. Thus, the URL constructed by playerCard_api.js for $http.get( ) call for obtaining filtered JSON dataset 256 of FIG. 3 will be http://explica.co/nba/stats/players/lebron-james.json.

Correspondingly, the response returned by the $http.get( ) call containing the filtered statistical NBA data for Lebron James is in JSON format as stated earlier. As already noted above, that in other variations, the above filtered data may follow some other format than JSON, for example, XML.

Now, let us present the HTML template correspondent to playerCard endpoint. As already explained, this template is used to produce the fully rendered HTML page. For a dataCard such as playerCard, this process utilizes the above provided data obtained from $http.get( ) call in the controller. The following representative code provides the partial HTML template showing the main aspects of the design, and correspondent to playerCard endpoint. This code is contained in playerCard_template_html.txt file submitted with the computer program listings appendix.

The code presented below is called after other dependent assets are loaded into the finally rendered web page. These dependent assets include stylesheets setting the responsive grid framework, colors, a master stylesheet explica.css containing the responsive type scale, individual sections and other styles. Of course, these assets, including stylesheet explica.css (submitted with the computer program listings appendix as explica_css.txt) constitute the web assets contained in collection 108 of FIG. 1 and collection 208 of FIG. 2-3.

These dependent assets are loaded in the <head></head> elements as well as “ng-view” <div> section of the final HTML, as evident from the finally rendered HTML files lebron-james_playerCard_html.txt and tracy-mcgrady_playerQuote_html.txt files. The above design allows for fast and dynamic loading of these assets for rapidly rendering a large number of web pages than otherwise possible. All these files are contained in the computer program listings appendix submitted with this disclosure.

playerCard template.html

```
<a class=“white” ng-
href=“http://explica.co/nba/player/{{toDash(stat[‘first-name’] +
‘ ’ + stat[‘last-name’])}}” ng-repeat=“stat in player”
target=“_parent”>
            <div class=“shadow-hover contra” ng-
style=“{‘background-image’:‘linear-gradient(
rgba(0,0,0,0),rgba(0,0,0,0),rgba(0,0,0,0.2),rgba(0,0,0,0.5),rgba(
0,0,0,0.9)),
url(&quot;http://explica.io/img/NBA/teams/’+toDash(stat[‘nba-
team’])+‘_bg.jpg&quot;)’}” style=“background-size: cover;
background-position: center center; margin: 20px auto; max-width:
500px;”>
                <small class=“upperspace hover-link”>CLICK TO
SEE MORE <i class=“fa fa-caret-right”></i></small>
                <div class=“padding”>
                        <div class=“row text-center”>
                            <div class=“col-xs-12 no_margin”>
                                <img class=“img-responsive”
style=“margin: 0 auto; margin-bottom: −30px; margin-top: −30px;
max-width: 100px” ng-
src=“http://explica.io/img/NBA/player/{{toDash(stat[‘first-name’]
+ ‘ ’ + stat[‘last-name’])}}.png”>
                                <h1 style=“text-shadow: 0 6px
10px rgba(0,0,0,0.8)”>{{stat[“first-name”] + “ ” + stat[“last-
name”]}}</h1>
                              <h4><b class=“white halfspace”
style=“text-transform: uppercase” ng-style=“{‘text-shadow’:‘0 3px
5px ’+ stat.accent }”> {{stat[“nba-team”]}} </b></h4><br/>
                                <hr>
                            </div>
                        </div>
                      <div class=“row padding-sm-lr”>
                        <div class=“col-xs-4”>
                              <h2><span ng-
style=“{‘color’:stat[‘accent-2’]}”>{{stat[stat1]}}</span><small
class=“white”>{{stat1}}</small></h2>
                          <p class=“upperspace multiply
semioptiny”style=“line-height: 1”><i ng-repeat=“b in [ ] | range:
stat[stat1]” class=“fa fa-circle”></i></p>
                        </div>
                        <div class=“col-xs-4”>
                          <h2><span ng-
style=“{‘color’:stat[‘accent-2’]}”>{{stat[stat2]}}</span><small
class=“white”> {{stat2}}</small></h2>
                          <p class=“upperspace multiply
semioptiny”style=“line-height: 1”><i ng-repeat=“d in [ ] | range:
stat[stat2]” class=“fa fa-circle”></i></p><br>
                        </div>
                        <div class=“col-xs-4”>
                          <h2><span ng-
style=“{‘color’:stat[‘accent-2’]}”>{{stat[stat3]}}</span><small
class=“white”>{{stat3}}</small></h2>
                          <p class=“upperspace multiply
semioptiny”style=“line-height: 1”><i ng-repeat=“a in [ ] | range:
stat[stat3]” class=“fa fa-circle”></i></p>
                          </div>
                    </div>
                </div>
            </div>
        </a>
```

The styling for the final HTML code is mostly set from a master stylesheet used for all cards. For the purpose of scalability for other industry verticals/genres, the HTML classes corresponding to specific layouts that repeat across the genres are divided similarly as the URLs for the web-api. These master styles are saved in the master CSS file explica.css. Using any modern browser, skilled artisans will find that the stylesheet is composed of sets of classes with commented headers, starting with general rules (responsive grid, typography scale) followed by groups of rules for different layouts, for examples, playerCard, playerBanner, playerQuote, etc. Such a flexible and expandable design provides for far more efficient web content-creation than is possible in the prevailing art.

As already explained that the HTML code rendered according to above teachings is device-responsive and is based on HTML5 technology standard. A device-responsive code allows the HTML page to dynamically adapt to the size of the browser window. Explained further, the device-responsive HTML5 code of the instant design is responsive to the size of the viewport of the browser, no matter how or if the user resizes the browser window.

This functionality is also very useful when the browser runs on a mobile device. This is because mobile devices come in a vast variety of display sizes and capabilities, so a device-responsive design allows the web page to dynamically adapt to the size of the viewport of the browser on the device. Those skilled in the art will understand that HTML5 provides for such a device-responsive behavior of a web page by its <meta>viewport element.

More specifically, the following HTML5 statements in lebron-james_playerCard_html.txt and tracy-mcgrady_playerQuote_html.txt files accomplish this objective:

<meta name=“viewport” content=“width=device-width, initial-
scale=1.0”>
<meta name=“viewport” content=“initial-scale=1, maximum-scale=1”>

A <meta> viewport element gives the browser instructions on how to control the dimensions and scaling of the page. The setting of “width” property as “width=device-width” sets the width of the page to follow the screen-width of the device (which will vary depending on the device). The setting of property “initial-scale=1.0” sets the initial zoom level when the page is first loaded by the browser. “maximum-scale” defines the maximum zoom. When the page is accessed, “maximum-scale=1” will not allow the user to zoom.

According to the instant techniques, each graphicle also has a colors style. The style for colors may be in a corresponding colors.css file or otherwise coded inline in the final HTML output as a <style> tag with property id=“color_css”. An exemplary colors.css file is submitted with the included computer program listings appendix as colors_css.txt file. Of course, colors.css constitutes an asset of the web assets collection of the present teachings, such as collection 108 and 208 of FIG. 1 and FIG. 2-3 respectively.

Individual elements are colored based on an array of 3 or more root colors. This is achieved using a standard design hierarchy to optimize for readability and contrast. Below is an example of CSS code snippet based on the above scheme. This code is used for the colors style used in the rendered HTML of FIG. 4 from the above lebron-james_gpe_m_decoded.txt graphicle.

```
/* COLORS */
:root {
  --foreground: #20252a;
  --background: #f2f2f2;
  --accent: #8B0034;
  --accent-2: #F9B433;
/* accent-3 user-defined and left blank */
  --accent-3:
}
.accent {
  color: var (--accent);
}
.accent-2 {
  color: var (--accent-2);
}
.accent-3 {
  color: var (--accent-3);
}
```

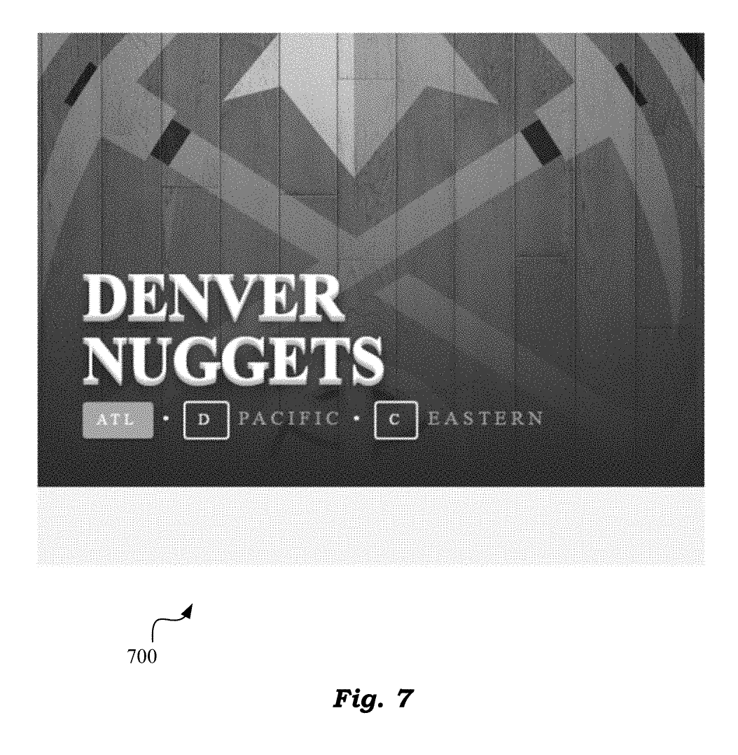

FIG. 7 provides an exemplary device-responsive web page 700. Web page 700 is rendered from a dataCard graphicle with an endpoint of teamCard by applying a corresponding HTML template according to the above teachings. Corresponding denver-nuggets.html file is contained as denver-nuggets_html.txt in the computer program listings appendix included with this disclosure. One readily sees the above-taught root colors along with the several accent colors defined in the file.

Furthermore, during the instant rendering process, text/font sizing is based on a typography scale which uses a series of font sizes based on a ratio. For instance, one may use the golden ratio, with an exemplary base size of 16 pixels. Then an exemplary cliff may be used for mobile devices at screen-width <468 pixels and base=21 pixels. This typography scale is coded within the master stylesheet explica.css contained in assets collection 108 of FIG. 1 and collection 208 of FIG. 2-3. Following snippet, provides exemplary font definitions based on the above techniques.

```
// Font size ratios (em)
    p : lem
    small : 0.78616em
    h6 : 1.272em
    h5 : 1.61798em
    h4 : 2.05807em
    h3 : 2.61787em
    h2 : 3.32993em
    h1 : 4.23568em
// At 480px to 1600px screen size
base : 18.045px
// 1600px+ screen size
base : 20.352px
```

The vast variety of computer systems architectures, technologies and design choices for the practice of present teachings will be apparent to skilled artisans. For example, in a highly secure implementation of the present design the posts generated by the CMS are stored in a MongoDB database to firmly secure the posts from unauthorized access. In the same or a related highly secure embodiment, the graphile/GPE files are stored locally in a secure manner by first applying a cipher, as mentioned earlier. Among the many choices for such a cipher, there is the simple substitution cipher, such as:

Substitution cipher = (n + 1)

1 => 2 2 => 3 3 => 4 5 => 6 6 => 7 7 => 8 8 => 9 9 => 0

Alternatively, the cipher may be a Caesar substitution cipher. As will be recognized by skilled artisans, such a cipher is given by:

Julius Caesar Cipher = (n + 7)

A => H B => I C => J D => K E => L F => M G => N H => O
I => P J => Q K => R L => S M => T N => U O => V P => W
Q => X R =>Y S => Z T => A U => B V => C W => D X => E
Y => F Z => G

Thus, by applying the Caesar cipher to lebron-james_gpe_m_decoded.txt file presented earlier, one obtains the secure version of the file suitable for local storage as a lebron-james_m.gpe file. Similarly, by applying a cipher to tracy-mcgrady_gpe_n_decoded.txt file presented earlier, one obtains the secure version of the file suitable for local storage as a tracy-mcgrady_gpe_n.gpe file.

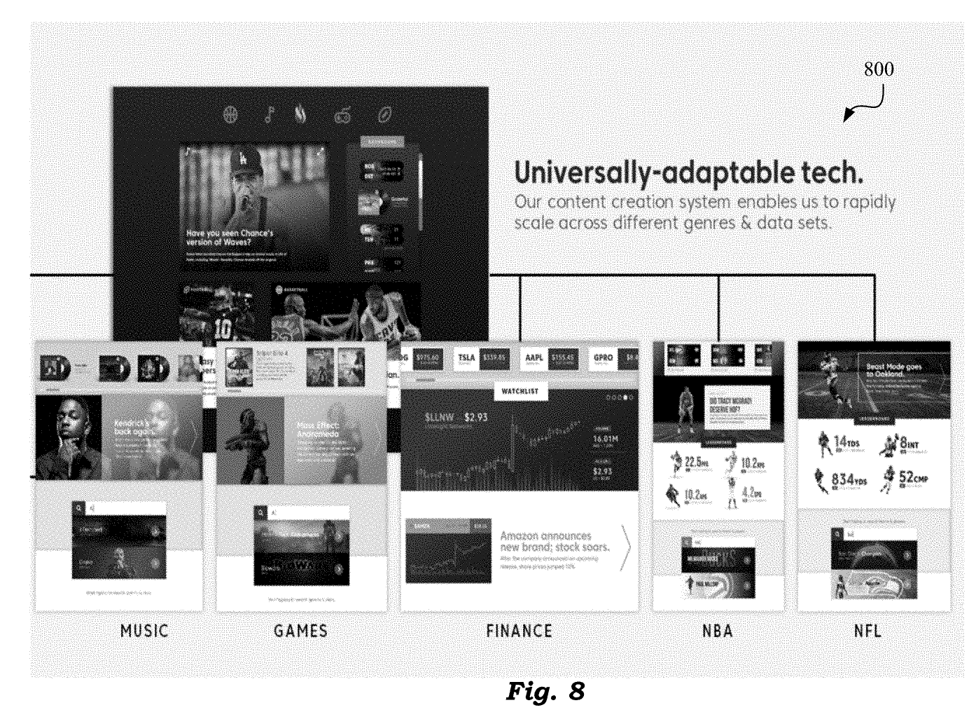

The present capability to generate content across different verticals, genres or topics with vastly different data types & datasets is indicated in FIG. 8. FIG. 8 shows a set 800 of verticals/genres/topics including but not limited to music, (video) games, finance and sports including NBA and NFL supported by the present techniques. Based on the above teachings, the HTML templates for these verticals/genres can be created with any web assets required to provide the desired look and feel for the rendered web pages.

In yet another useful set of variations of the present design, and referring back to FIG. 3, web api 252 does not apply a predefined HTML template as shown by process/box 258. Instead, web-api 252 dynamically generates finally rendered HTML page 204 without the use of a predefined HTML template. This generation of HTML is based on a set of predefined rules or heuristics contained in web-api 252. These rules/heuristics may be universal or dependent upon the type of graphicle being rendered.

Based on these rules, web-api 252 thus generates HTML code 204 from filtered JSON dataset 256 for a dataCard. Analogously, based on the same or different set of rules, web-api 252 thus generates HTML code 204 directly from data 259 contained in the URI parameters of incoming call/URL 251 for a layoutCard. For the above dynamic generation of HTML, web-api 252 directly accesses the web assets contained in collection 208 without the predefined HTML templates of the prior embodiments that in turn referenced web assets of collection 208. The rest of the teachings of the prior embodiments apply to the present set of embodiments also.

The design of the present embodiments is useful because one can implement web_api 252 in even more of a self-contained manner. Also, in such an implementation, there is no requirement to maintain the many different types of HTML templates. Furthermore, web-api 252 can consist of JavaScript code that directly generates final HTML 204 without the use of a JavaScript framework such as AngularJS or another similar framework.

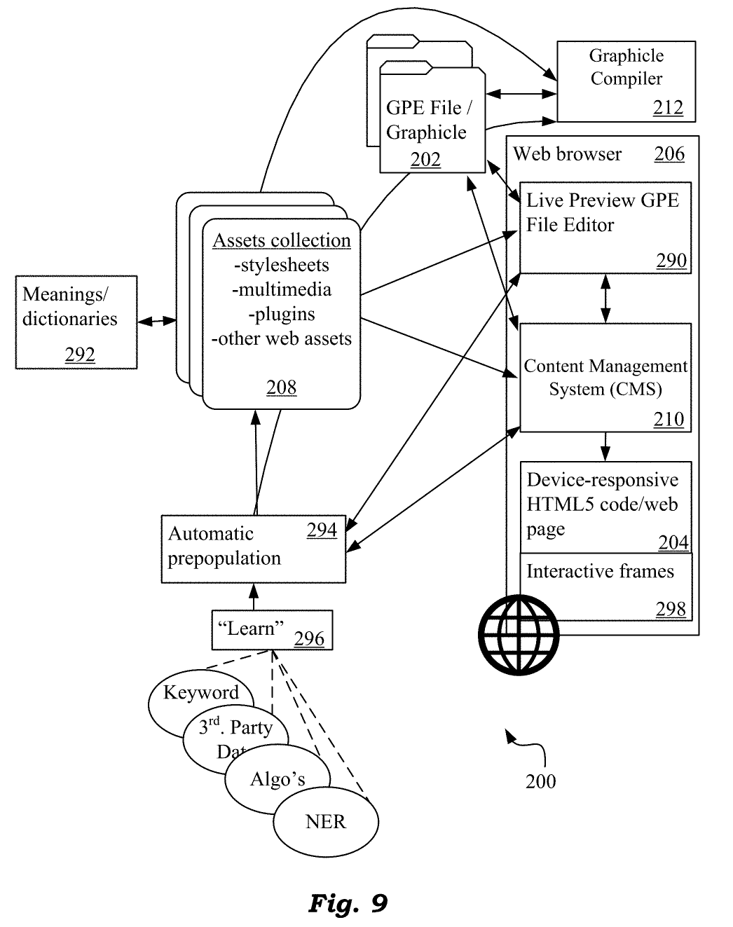

FIG. 9 illustrates several other components of the ecosystem of web content-creation infrastructure 200 of FIG. 2 based on the present principles. More specifically, FIG. 9 shows one or more GPE/graphicle files 202 that can be edited by a user via a live-preview editor 290. As per earlier explanation, a content management system (CMS) 210 is used to manage the GPE files in the system. In the embodiment shown in FIG. 9, CMS 210 and/or live-preview editor 290, and/or graphicle compiler 212 explained earlier, interact with assets collection 208 via web-api('s) per earlier teachings.

They thus render device responsive HTML code 204 from graphical file(s) 202. As before, the code/web page(s) is/are directly viewable in a typical web browser 206. As shown in FIG. 9, editor 290 and CMS 210 are both web applications executable within browser 206. Note that for clarity, web-api 252 of FIG. 3 and its corresponding incoming and outgoing calls/responses are not explicitly shown in FIG. 9 to avoid clutter. Graphicle compiler 212 is typically a standalone application which may or may not be command line application, such as gcc, or g++. That is why compiler 212 is shown outside of browser 206.

During the rendering process, rendering module/function may also generate interactive frames 298 in its rendered HTML code 204. To achieve its rendering objectives, CMS 210 uses an assets collection or database 208 of web assets. Collection 208 may be deployed using one of the many available database technologies. In a useful variation, collection 208 may simply be a collection of disparate files corresponding to the web assets. In any case, collection 208 may be populated manually or by an automated pre-population module 294, which may be implemented as an API.

Such a pre-population API will have a component or executable portion for editor 290 and another component or executable portion for CMS 210. Alternatively, there may be two separate and related API's, one for module 210 and another for module 290. In any event, working in conjunction with CMS 210 and/or editor 290, automatic pre-population function 294 may also have a learning capability 296 that discovers and “learns” various web assets over time by a variety of methods.

The learning may discover and store in collection 208 newer/better stylesheets, images, audios, videos, feeds, 3D elements, plugins etc. Learning methods may be based on recognizing keywords typed by the user in CMS 210 and/or editor 290, identifying third-party data sources, incorporating various algorithms, and the like. These methods may also utilize named entity recognition (NER) based techniques, including teaching the system certain meanings or dictionaries 292 of categorized known entities, for example, important people, cities, registered companies, etc.

In view of the above teaching, a person skilled in the art will recognize that the apparatus and methods of invention can be embodied in many different ways in addition to those described without departing from the principles of the invention. Therefore, the scope of the invention should be judged in view of the appended claims and their legal equivalents.

What is claimed is:

1. A computer system of content-creation for the world wide web (WWW), comprising:
(a) a non-transitory storage medium storing computer-readable program instructions and a microprocessor coupled to said non-transitory storage medium for executing said program instructions;
(b) a text file containing one or more sections, said one or more sections specifying one or more Uniform Resource Identifier (URI) parameters to identify an endpoint of a web-api hosted on a server of said computer system;
(c) a device-responsive web page based on HTML5 technology standard and served at said endpoint by said web_api;
(d) a collection of web assets comprising at least one of a stylesheet, a multimedia content and a plugin; and
(e) said web_api configured to utilizing said collection for rendering said device-responsive web page from said text file for said content-creation.

2. The system of claim 1 wherein said web-api utilizes a predefined HTML template referencing said web assets for said rendering, said predefined HTML template correspondent to said endpoint.

3. The system of claim 2 wherein said one or more URI parameters further identify a JavaScript Object Notation (JSON) dataset which said web-api filters to obtain a filtered JSON dataset, and then said web-api applies said predefined HTML template to said filtered JSON dataset for said rendering.

4. The system of claim 2 wherein said web-api applies said predefined HTML template directly to data supplied in said one or more URI parameters.

5. The system of claim 2 wherein said one or more sections are semantically organized.

6. The system of claim 1 wherein said stylesheet comprises one or more of a cascading stylesheet (CSS), a Less stylesheet, and a synthetically awesome stylesheet (SaSS), and said multimedia content comprises one or more of a picture, an animation, an audio, a video, a 3D element and a live-scraped datum.

7. The system of claim 1 wherein said collection further comprises one or more software modules containing Asynchronous JavaScript and XML (Ajax) based dynamic code.

8. The system of claim 1 wherein a compiler is used to compile said text file for said rendering.

9. The system of claim 1 wherein a content management system is used for said rendering.

10. The system of claim 1 wherein said device-responsive web page has a layout correspondent to said endpoint.

11. The system of claim 10 wherein said device-responsive web page has a color style that is based on an array of three or more root colors and has a font sizing that is based on a typography scale.

12. A system of content-creation for the world wide web (WWW), comprising:
(a) at least one non-transitory storage medium storing computer-readable program instructions and at least one microprocessor coupled to said at least one non-transitory storage medium for executing said program instructions;
(b) a plurality of text files, each comprising one or more sections specifying one or more Uniform Resource Identifier (URI) parameters to identify an endpoint of a web-api from one or more web_api's hosted on said one or more microprocessors;
(c) a plurality of device-responsive web pages, each correspondent to one of said plurality of text files, said plurality of device-responsive web pages based on HTML5 technology standard; and
(d) a collection of web assets comprising at least one of a stylesheet, a multimedia content and a plugin;
wherein said one or more web-api's utilize said collection for rendering said plurality of device-responsive web pages correspondent to said plurality of text files, for said content-creation.

13. A computer-implemented method of content-creation for the world wide web (WWW) by a microprocessor executing program instructions stored in a non-transitory computer-readable storage medium, comprising the steps of:
(a) storing a text file containing one or more sections, said one or more sections specifying one or more Uniform Resource Identifier (URI) parameters identifying an endpoint of a web-api hosted on a web server;
(b) storing a collection of web assets, said web assets comprising at least one of a stylesheet, a multimedia content and a plugin; and
(c) said web-api utilizing said collection for rendering a device-responsive HTML5 web page from said text file for said content-creation.

14. The method of claim 13 configuring said web-api to utilize a predefined HTML template referencing said web assets for said rendering, said predefined HTML template correspondent to said endpoint.

15. The method of claim 14 configuring said web-api to filter a JavaScript Object Notation (JSON) dataset based on said one or more URI parameters to obtain a filtered JSON dataset, and then to apply said predefined HTML template to said filtered JSON dataset for said rendering.

16. The method of claim 14 configuring said web-api to apply said predefined HTML template directly to data supplied in said one or more URI parameters.

17. The method of claim 13 utilizing a compiler for compiling said text file for said rendering.

18. The method of claim 13 utilizing a content management system for said rendering.

19. The method of claim 13 having a layout for said device-responsive web page that is correspondent to said endpoint.

20. The method of claim 13 having a color style for said device-responsive web page that is based on an array of three or more root colors and has a font sizing that is based on a typography scale.
